(19) United States
(12) Patent Application Publication
(10) Pub. No.: US 2012/0049694 A1
(43) Pub. Date: Mar. 1, 2012

(54) Micromachined Piezoelectric Energy Harvester with Polymer Beam

(75) Inventors: Rob van Schaijk, Eindhoven (NL); Martijn Goedbloed, Aachen (DE)

(73) Assignee: Stichting IMEC Nederland, Eindhoven (NL)

(21) Appl. No.: 13/217,118

(22) Filed: Aug. 24, 2011

Related U.S. Application Data
(60) Provisional application No. 61/377,625, filed on Aug. 27, 2010.

(51) Int. Cl. H02N 2/18; H04R 17/00

(52) U.S. Cl. 310/339; 29/25.35

(57) ABSTRACT

A micromachined piezoelectric energy harvester and methods of fabricating a micromachined piezoelectric energy harvester are disclosed. In one embodiment, the micromachined piezoelectric energy harvester comprises a resonating beam formed of a polymer material, at least one piezoelectric transducer embedded in the resonating beam, and at least one mass formed on the resonating beam. The resonating beam is configured to generate mechanical stress in the at least one piezoelectric transducer, and the at least one piezoelectric transducer is configured to generate electrical energy in response to the mechanical stress.

### CROSS-REFERENCE TO RELATED APPLICATION

This application is a non-provisional of U.S. Provisional Patent Application Ser. No. 61/377,625 filed Aug. 27, 2010, the contents of which are hereby incorporated by reference.

### BACKGROUND

The present disclosure relates to a micromachined piezoelectric energy harvester comprising a resonating beam and to a method for fabricating such a micromachined energy harvester.

Future wireless sensor networks will comprise sensor nodes that occupy a volume of typically a few cm³. The scaling down of batteries for powering these sensor nodes faces technological restrictions as well as a loss in storage density. For this reason, a worldwide effort is ongoing to replace batteries with more efficient, miniaturized power sources. Energy harvesters based on the recuperation of waste ambient energy are a possible alternative to batteries. Several harvesting concepts have been proposed, based on the conversion of thermal energy, pressure energy, or kinetic energy.

Kinetic energy harvesters or vibration energy harvesters convert energy in the form of mechanical movement (e.g. in the form of vibrations or random displacements) into electrical energy. For the conversion of kinetic energy into electrical energy, different conversion mechanisms may be employed. For example, piezoelectric conversion can be employed, using piezoelectric materials that generate a charge when mechanically stressed.

Piezoelectric energy harvesters are often resonant systems having a resonant frequency given by

$$f = \sqrt{\frac{k}{m}} ,$$

where k is the stiffness and m the mass of a resonator. For many applications, a low resonance frequency (e.g., lower than 100 Hz) is needed. This can be obtained by increasing the mass or by lowering the stiffness of the resonating beam.

A possible route towards lower-cost harvesting devices is using microsystems manufacturing technology. Micromachined devices can be made on a wafer basis in a batch mode, greatly reducing the cost.

However, for micromachined resonators, such as micromachined piezoelectric energy harvesters, it is sometimes difficult to increase the mass of the resonator. Accordingly, for micromachined piezoelectric harvesters, the resonant frequency may be best lowered by lowering the stiffness of the resonator.

Using a standard single clamped beam harvester with a silicon beam, the lower limit of resonance is typically about 150 Hz for a device size up to 1 cm². This lower limit results from the high stiffness of a silicon beam and the small device size.

Besides the requirement of a low resonance frequency, the power output of the micromachined energy harvester is preferably as high as possible. Therefore, the stiffness of a resonating beam of the piezoelectric harvester should be sufficiently high to generate a sufficient amount of strain in a piezoelectric transducer of the micromachined piezoelectric energy harvester.

### SUMMARY

Disclosed is a micromachined piezoelectric energy harvesters having a lower resonance frequency without an increased device size. Also disclosed is a method for manufacturing such a micromachined piezoelectric energy harvester.

In one aspect, a micromachined piezoelectric energy harvester is disclosed comprising a resonating beam formed of a polymer material, at least one piezoelectric transducer embedded in the resonating beam, and at least one mass formed on the resonating beam. The resonating beam is configured to generate mechanical stress in the at least one piezoelectric transducer, and the at least one piezoelectric transducer is configured to generate electrical energy in response to the mechanical stress.

In another aspect, a micromachined piezoelectric energy harvester is disclosed comprising a first polymer sub-beam comprising a first surface and a second surface opposite the first surface. The first polymer sub-beam comprises a first piezoelectric transducer embedded in the first polymer sub-beam, and a first mass attached to the first surface of the first polymer sub-beam. The micromachined piezoelectric energy harvester further comprises a second polymer sub-beam comprising a first surface and a second surface opposite the first surface. The second polymer sub-beam comprises a second piezoelectric transducer embedded in the second polymer sub-beam, and a second mass attached to the first surface of the second polymer sub-beam. The second surface or the first polymer sub-beam and the second surface of the second polymer sub-beam are connected such that the first polymer sub-beam and the second polymer sub-beam form a resonating beam.

In yet another aspect, a method for fabricating a micromachined piezoelectric energy harvester is disclosed. The method comprises fabricating a first device part comprising a first polymer sub-beam comprising a first surface and a second surface, a first piezoelectric transducer embedded in the first polymer sub-beam, and a first mass attached to the first surface of the first polymer sub-beam. The method further comprises fabricating a second device part comprising a second polymer sub-beam comprising a first surface and a second surface, a second piezoelectric transducer embedded in the second polymer sub-beam, and a second mass attached to the first surface of the second polymer sub-beam. The method still further comprises bonding the first device part to the second device part such that the second surface of the first polymer sub-beam is contact with the second surface of the second polymer sub-beam, thereby forming a resonating beam from the first polymer sub-beam and the second polymer sub-beam. The method further comprises performing an etch to release the resonating beam.

In some embodiments, the method may further comprise providing a first cover plate at a first side of the polymer beam and providing a second cover plate at a second side of the polymer beam. The first cover plate and the second cover plate may together form a package for the resonating beam and the at least one mass.

In some embodiments, the disclosed method may be based on silicon microelectromechanical system (MEMS) processing. This allows high volume manufacturing at low cost.

In some embodiments, the resonating beam may be made of a polymer. Further, in some embodiments, the resonating beam may have a lower stiffness than typical micromachined devices of comparable dimensions (e.g., micromachined devices smaller than 1 cm² and having, for example, silicon beams), resulting in a lower resonance frequency.

The disclosed micromachined piezoelectric energy harvester may have improved reliability as compared to typical micromachined devices (e.g., micromachined devices having, for example, silicon beams). This may be because the resonating beam in the disclosed micromachined piezoelectric energy harvester may be made of a polymer that is less brittle than silicon, allowing the micromachined piezoelectric energy harvester to withstand larger shocks.

In some embodiments, the resonating beam may comprise a clamped beam, such as a single-side clamped beam (cantilever) or a double-side clamped beam.

In some embodiments, the polymer of which the resonating beam is made may have a Young's modulus lower than, for example, 20 GPa. Further, the resonance frequency of the disclosed micromachined piezoelectric energy harvester may bein the range of, for example, 50 Hz to 200 Hz. Still further, the power output of the disclosed micromachined piezoelectric energy harvester may be in the range f, for example, 10 μW/cm² to 100 μW/cm².

In some embodiments, the at least one mass may comprise a first mass attached to a first surface of the resonating beam and a second mass attached to a second surface of the resonating beam. The second surface may be opposite to the first surface. The first mass and/or the second mass may be, for example, silicon masses. However, the present disclosure is not limited thereto, and materials other than silicon can be used for forming at least part of the first and/or second mass. In these embodiments, a total mass of the first mass and the second mass may exceed a total mass of typical micromachined devices, resulting in a lower resonance frequency and a larger power output.

In some embodiments, the disclosed micromachined piezoelectric energy harvester may have a symmetric structure, resulting in a compensation of stresses. In some embodiments, the symmetry of the manufactured micromachined piezoelectric energy harvester can provide stress compensation. In non-symmetric structures, such as a structure comprising a single polymer beam with a single piezoelectric transducer and a single mass, a large amount of stress could be present in the single polymer beam due to the presence of a piezoelectric transducer on top of or embedded in the polymer beam, and after release of the polymer beam, the beam could bend as a result of this stress. The stress can be compensated for by adding stress compensating layers, but this is a difficult process. Rather, in embodiments of the disclosed methods, two device parts, each comprising a polymer sub-beam with an embedded piezoelectric transducer, are bonded before release of the polymer beam. In this way, a symmetric micromachined piezoelectric energy harvester is obtained, and the stress is compensated, regardless of device sizes and designs.

### BRIEF DESCRIPTION OF THE DRAWINGS

The disclosure will be further elucidated by means of the following description and the appended drawings.

FIG. 1 shows a schematic cross-section of a micromachined piezoelectric energy harvester, in accordance with an embodiment.

FIGS. 2A-D illustrate a process flow for fabricating a first device part for use in a micromachined piezoelectric energy harvester, in accordance with an embodiment.

FIGS. 3A-D illustrate a process flow for fabricating a second device part for use in a micromachined piezoelectric energy harvester, in accordance with an embodiment.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

A micromachined piezoelectric energy harvester according to embodiments of the present disclosure comprises a resonator comprising a resonating beam. The resonating beam may be a single-side or double-side clamped beam having a low Young's modulus. In some embodiments, the micromachined piezoelectric harvester is may be silicon-based, and the resonating beam may be a polymer beam. As compared to typical micromachined resonators in which a silicon beam is used, this results in a lower stiffness for the same resonating beam dimensions because of the lower Young's modulus of a polymer as compared to silicon. The lower stiffness results in a lower resonance frequency.

The resonator may further comprise at least one piezoelectric transducer integrated with or embedded in the resonating beam. In some embodiments, the at least one piezoelectric transducer may comprise a first piezoelectric transducer and a second piezoelectric transducer. The first piezoelectric transducer and the second piezoelectric transducer may be symmetrically integrated with or embedded in the resonating beam.

The resonator may further comprise at least one mass attached to a surface of the resonating beam. In some embodiments, the at least one mass may comprise a first mass and a second mass. The first mass and the second mass may be attached to opposite surfaces of the resonating beam. For example, the first mass may be attached to a first surface of the resonating beam, and the second mass may be attached to a second surface of the resonating beam. The first surface may be opposite the second surface. In some embodiments, a total mass of the first mass and the second mass may exceed a total mass of typical micromachined devices, resulting in a lower resonance frequency and a larger power output.

In manufacturing the disclosed micromachined piezoelectric energy harvester, the polymer resonating beam may be formed from two device parts, each of which comprises a polymer sub-beam with an integrated piezoelectric transducer. In particular, the two device parts may be bonded on top of each other such that the bonded polymer sub-beams form a single polymer resonating beam. Once the two device parts are bonded, the single polymer resonating beam may be released. In this way, the stress can be compensated for all device sizes and designs in the configuration of the device itself, and bending of the single polymer resonating beam after release can be avoided. No new stress optimization is needed every time the layer stack or thickness in the process flow is changed.

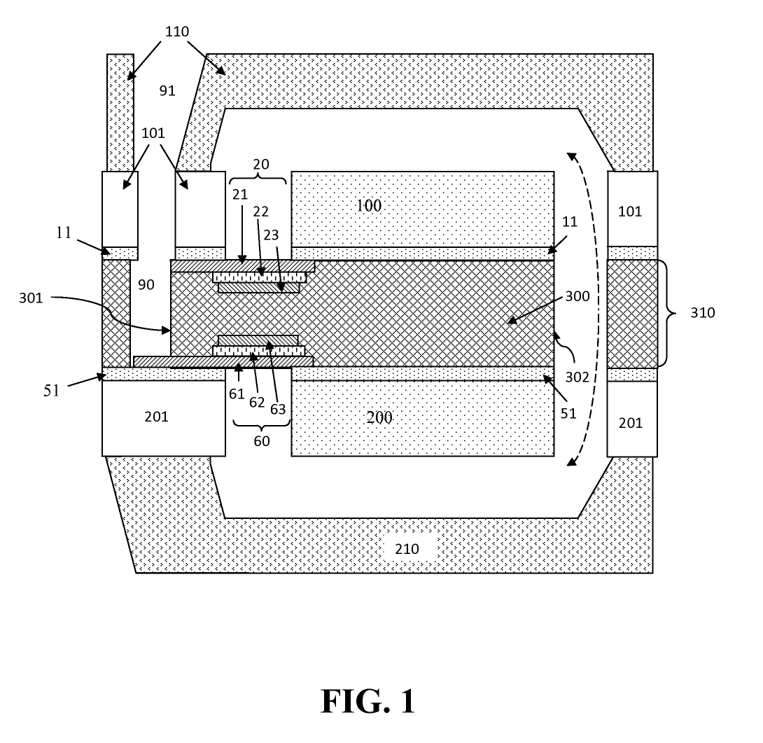

FIG. 1 shows a schematic cross-section of a micromachined piezoelectric energy harvester, in accordance with an embodiment. As shown, the micromachined piezoelectric energy harvester comprises a single-side clamped polymer resonating beam 300, a first silicon mass 100 attached to a first surface of the polymer resonating beam 300, and a second silicon mass 200 attached to a second surface of the polymer resonating beam 300. As shown, the second surface is opposite the first surface.

As shown, the micromachined piezoelectric energy harvester further comprises a first piezoelectric transducer 20 embedded in the polymer resonating beam 300, and a second piezoelectric transducer 60 embedded in the polymer resonating beam 300. In the example shown, the first piezoelectric transducer 20 is a piezoelectric capacitor structure comprising a stack of a first electrode 21, a piezoelectric layer 22 and a second electrode 23. The first piezoelectric transducer 20 is embedded in the first surface of the polymer resonating beam 300. Similarly, in the example shown, the second piezoelectric transducer 60 is a piezoelectric capacitor structure comprising a stack of a first electrode 61, a piezoelectric layer 62 and a second electrode 63. The second piezoelectric transducer 60 is embedded in the second surface of the polymer resonating beam 300. In other embodiments, a configuration with a single piezoelectric capacitor structure can be used. Alternately or additionally, instead of a piezoelectric capacitor stack, each piezoelectric transducer may comprise two interdigitated electrodes at one side of the piezoelectric layer. Still alternately or additionally, a plurality of series connected transducers may be provided, leading to a higher output voltage of the micromachined piezoelectric energy harvester. These examples are not limiting, and still other suitable configurations can be used.

At a first end 301, the polymer resonating beam 300 is clamped. Further at the first end 301, the polymer resonating beam 300 is physically attached to a frame or a support structure. As shown, the support structure comprises a first support part 101 and a second support part 201. The first support part 101 is connected to the second support part 201 by a polymer layer 310. In some embodiments, the polymer layer 310 may be the same layer as the polymer layer from which the polymer resonating beam 300 is fabricated. However, the present disclosure is not limited thereto, and the material used for forming the bonding polymer layer 310 can be different from the material used for forming the polymer resonating beam 300.

At a second end 302 opposite the first end 301, the polymer resonating beam 300 is free to move in a direction indicated by the dashed arrow. Further at the second end 302, a first mass 100 and a second mass 200 are provided. Further, a first piezoelectric transducer 20 is integrated with or embedded in the polymer resonating beam 300 at a location between the first mass 100 and the first end 301, and a second piezoelectric transducer 60 is integrated with or embedded in along the polymer resonating beam 300 at a location between the second mass 200 and the first end 301.

As shown, a contact hole 90 is provided through the first support part 101 and through the polymer layer 310 towards the first electrode 61 of the second piezoelectric transducer 60, such that an electrical contact can be made to both the first transducer 20 and the second transducer 60 from a same side of the micromachined piezoelectric energy harvester. Alternatively, electrical contacts to the first piezoelectric transducer 20 and the second piezoelectric transducer 60 may be provided on opposite sides of the micromachined piezoelectric energy harvester. a single side of the harvester.

The micromachined piezoelectric energy harvester further comprises a dielectric layer 11 between the first mass 100 and first support part 101, and between the polymer resonating beam 300 and the piezoelectric transducer 20. The micromachined piezoelectric energy harvester further comprises a dielectric layer 51 between the second mass 200 and the second support part 201, and between the polymer resonating beam 300 and the piezoelectric transducer 60. These dielectric layers 11, 51 provide electrical isolation between the piezoelectric transducers 20, 60 and other parts of the micromachined piezoelectric energy harvester. In addition, these dielectric layers 11, 51 may serve as an etch stop layer during fabrication of the micromachined piezoelectric energy harvester, as described below.

The micromachined piezoelectric energy harvester further comprises a first cover plate 110 and a second cover plate 210. Together the first cover plate 110 and the second cover plate 210 form a package for the polymer resonating beam 300, the first mass 100, and the second mass 200. As shown, the first cover plate 110 is attached to the first support part 101, and the second cover plate 210 is attached to the second support part 201. In between the first cover plate 110 and the second cover plate 210, sufficient space is left to enable the up-and-down movement of the polymer resonating beam 300 indicated by the dashed arrows. As shown in FIG. 1, an opening 91 is provided in the first cover plate 110 to allow access to the piezoelectric transducers 20, 60.

In operation, when the support parts 101 and 102 move, for example due to external vibrations, the masses 100 and 200 move up and down (as indicated by the dashed arrows in FIG. 1), resulting in bending of the polymer resonating beam 300 at the location of the first piezoelectric transducer 20 and the second piezoelectric transducer 60. This bending of the polymer resonating beam 300 creates an electrical potential difference between the first electrode 21 and second electrode 23 of the first piezoelectric transducer 20, and between the first electrode 61 and second electrode 63 of the second piezoelectric transducer 60. These potential differences can then be converted to electrical energy by proper circuitry (not shown).

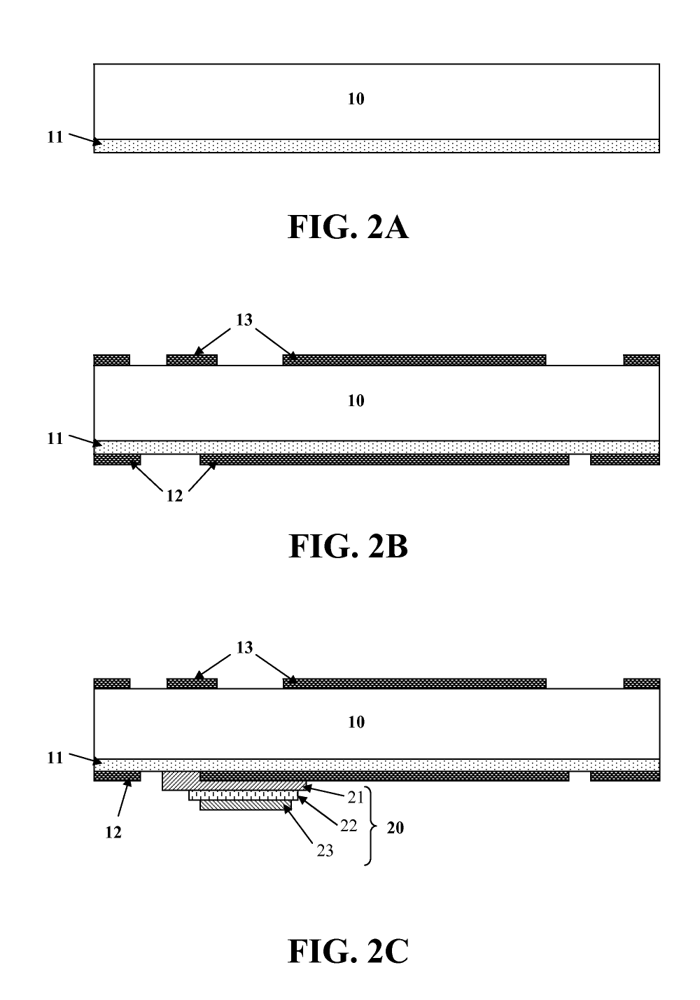

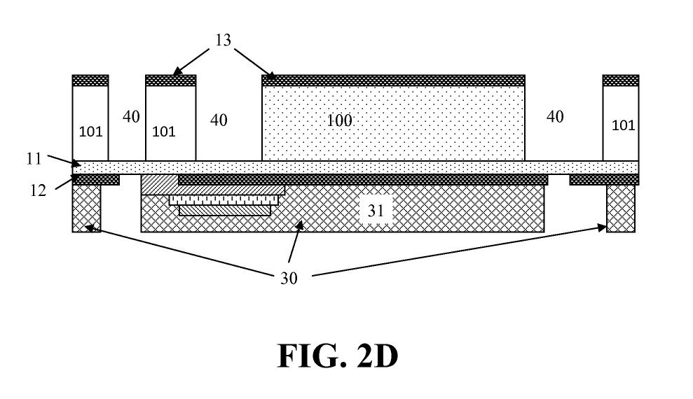

FIGS. 2A-D illustrate a process flow for fabricating a first device part for use in a micromachined piezoelectric energy harvester, in accordance with an embodiment. It is to be understood, however, the present disclosure is not limited thereto and other suitable fabrication processes may be used.

As shown in FIG. 2A, a first device wafer 10 is provided. The first device wafer 10 may be, for example, a silicon wafer. At a first side of the first device wafer 10, a dielectric layer 11 is provided. The dielectric layer 11 may be formed of a number of materials, such as, for example, an oxide, silicon nitride, silicon carbide, aluminum oxide, or any other suitable material known to a person skilled in the art. Further, the dielectric layer 11 may have a thickness in the range of, for example, 10 nm to 10 μm.

As shown in FIG. 2B, a first hard mask layer 12 may be provided on the dielectric layer 11. The first hard mask layer 12 may be, for example, a silicon nitride layer. Other materials are possible as well. Further, as shown in FIG. 2B, a second hard mask layer 13 may be provided on a second side (opposite the first side) of the first device wafer 10. The second hard mask layer 13 may be, for example, a silicon nitride layer. Other materials are possible as well.

The first and second hard mask layers 12, 13 may then be patterned. In particular, the first hard mask 12 may be removed at a location where a contact hole to a piezoelectric transducer will need to be provided, and at locations where a polymer resonating beam release etching will need to be performed. Further, the second hard mask layer 13 may be removed at locations where trenches will need to be etched to form a first mass and a contact hole. The patterned first and second hard mask layers 12, 13 are shown in FIG. 2B.

As shown in FIG. 2C, a first piezoelectric transducer 20 is provided on the first hard mask layer 12. In the example shown, the first piezoelectric transducer 20 is a capacitor structure comprising a stack of layers, the stack comprising a first electrode 21, a piezoelectric layer 22, and a second electrode 23. In some embodiments, the first piezoelectric transducer 20 may be positioned across from an opening defined in the second hard mask layer 13, as shown. This enables later contacting of the first piezoelectric transducer 20.

As shown in FIG. 2D, a first polymer layer 30 may be provided over the first hard mask layer 12 and the first piezoelectric transducer 20. The first polymer layer 30 may comprise, for example, Su-8, benzocyclobutene (BCB), or parylene. Other materials are possible as well. In some embodiments, the first polymer layer 30 may comprise a combination of different polymer layer, such as a stack of different polymers layers.

The first polymer layer 30 may then be patterned to form a first polymer sub-beam 31. In particular, the first polymer layer 30 may be removed a location where a contact hole to a piezoelectric transducer will need to be provided, and at locations where a polymer resonating beam release etching will need to be performed.

Further, the first device wafer 10 may be etched from the second side of the first device wafer 10, using the second hard mask layer 13 as a mask and using the dielectric layer 11 as an etch stop layer. The etching may be done using, for example, Deep Reactive Ion Etching. Other etching techniques are possible as well. As a result of the etching, trenches 40 may be formed through the first device wafer 10. A remaining portion of the first device wafer 10 may server as a first mass 100. Other remaining portions of the first device wafer 10 may server as a first support part 101.

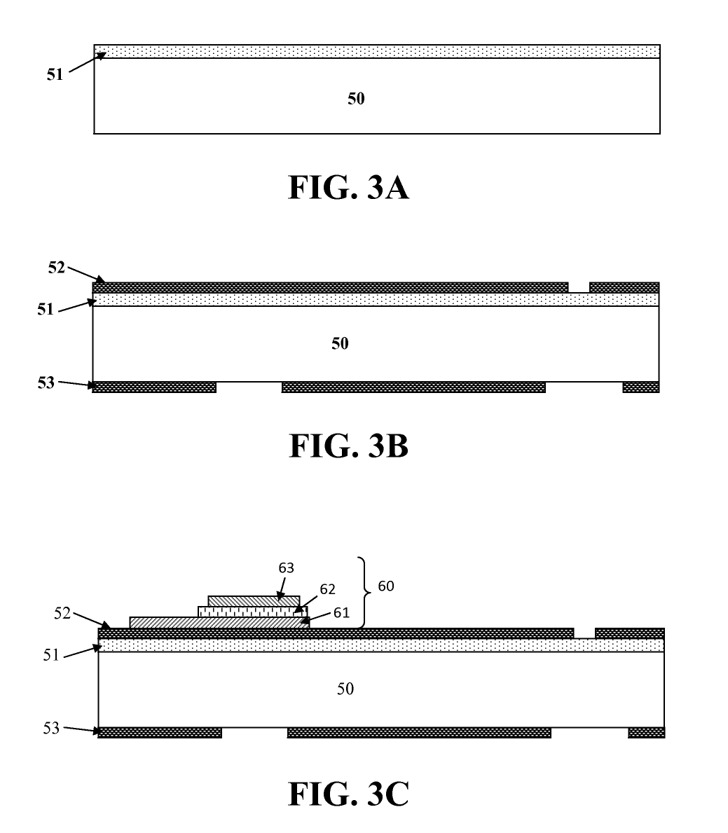

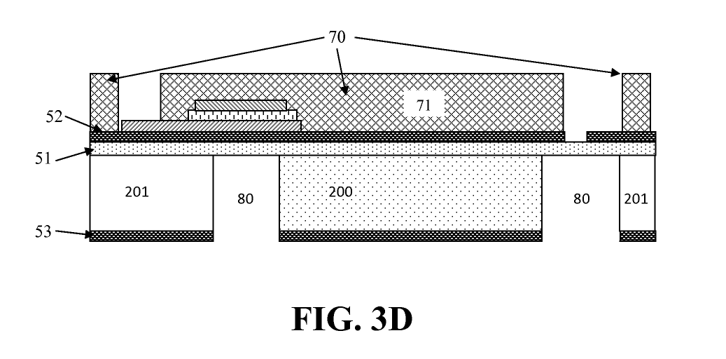

FIGS. 3A-D illustrate a process flow for fabricating a second device part for use in a micromachined piezoelectric energy harvester, in accordance with an embodiment. It is to be understood, however, the present disclosure is not limited thereto and other suitable fabrication processes may be used.

As shown in FIG. 3A, a second device wafer 50 is provided. The second device wafer 50 may be, for example, a silicon wafer. At a first side of the second device wafer 50, a dielectric layer 51 is provided. The dielectric layer 51 may be formed of a number of materials, such as, for example, an oxide, silicon nitride, silicon carbide, aluminum oxide, or any other suitable material known to a person skilled in the art. Further, the dielectric layer 51 may have a thickness in the range of, for example, 10 nm to 10 μm.

As shown in FIG. 3B, a first hard mask layer 52 may be provided on the dielectric layer 51. The first hard mask layer 52 may be, for example, a silicon nitride layer. Other materials are possible as well. Further, as shown in FIG. 3B, a second hard mask layer 53 may be provided on a second side (opposite the first side) of the second device wafer 50. The second hard mask layer 53 may be, for example, a silicon nitride layer. Other materials are possible as well.

The first and second hard mask layers 52, 53 may then be patterned. In particular, the first hard mask 52 may be removed at a location where a polymer resonating beam release etching will need to be performed. Further, the second hard mask layer 13 may be removed at locations where trenches will need to be etched to form a second mass. The patterned first and second hard mask layers 52, 53 are shown in FIG. 3B.

As shown in FIG. 3C, a second piezoelectric transducer 60 is provided on the first hard mask layer 52. In the example shown, the first piezoelectric transducer 20 is a capacitor structure comprising a stack of layers, the stack comprising a first electrode 61, a piezoelectric layer 62, and a second electrode 63.

As shown in FIG. 3D, a second polymer layer 70 may be provided over the first hard mask layer 52 and the second piezoelectric transducer 60. The second polymer layer 70 may comprise, for example, Su-8, benzocyclobutene (BCB), or parylene. Other materials are possible as well. In some embodiments, the second polymer layer 70 may comprise a combination of different polymer layer, such as a stack of different polymers layers.

The second polymer layer 70 may then be patterned to form a second polymer sub-beam 71. In particular, the second polymer layer 70 may be removed a location where a contact hole will need to be provided, and at locations where a polymer resonating beam release etching will need to be performed.

Further, the first device wafer 10 may be etched from the second side of the second device wafer 50, using the second hard mask layer 53 as a mask and using the dielectric layer 51 as an etch stop layer. The etching may be done using, for example, Deep Reactive Ion Etching. Other etching techniques are possible as well. As a result of the etching, trenches 80 may be formed through the second device wafer 50. A remaining portion of the second device wafer 50 may server as a second mass 200. Other remaining portions of the second device wafer 50 may server as a second support part 201. In some embodiments, such as that shown, there may be no need to provide a contact hole through the second device wafer 50, as a contact hole through to the second piezoelectric transducer 60 may be possible through the first device wafer 10. In other embodiments, however, a contact hole through to the second piezoelectric transducer 60 may be provided.

The first device part shown in FIG. 2D and the second device part shown in FIG. 3D may then be bonded together to form the micromachined piezoelectric energy harvester shown in FIG. 1. In particular, the second side of the first device part (on which the first polymer layer 30 is formed) and the second side of the second device part (on which the second polymer layer 70 is formed) may be bonded together, such that the first polymer layer 30 and the second polymer layer 70 form a single polymer layer 310. The first sub-beam 31 (shown in FIG. 2D) of the first polymer layer 30 and the second polymer sub-beam 71 (shown in FIG. 3C) of the second polymer layer 70 may combine to form a polymer resonating beam 300, as shown in FIG. 1.

Following the bonding, an etch may be performed at both sides of the bonded structure, thereby removing the exposed parts of dielectric layer 11 and of dielectric layer 51. The etch may be, for example, a wet etch (e.g., an HF etch) or a dry etch. Other etches are possible as well. As a result of the etch, the polymer resonating beam 300 may be released.

Following the etch, a first cover plate 110 may be attached to the first support part 101, and a second cover plate 210 may be attached to the second support part 201, thereby forming a package for the polymer resonating beam 300, the first mass 100, and the second mass 200. The polymer resonating beam 300, the first mass 100, and the second mass 200 may be said to form a resonator for the micromachined piezoelectric energy harvester.

In some embodiments, attaching the first cover plate 110 to the first support part 101, and attaching the second cover plate 210 to the second support part 201, may be done using wafer bonding. In these embodiments, a layer of bonding material, such as a polymer material, can be provided at the non-etched portions of the first cover plate 110 and the second cover plate 210 to enable this wafer bonding.

The first cover plate 110 and the second cover plate 210 may be fabricated from, for example, a glass wafer or a silicon wafer, or any other suitable material known to a person skilled in the art.

The first cover plate 110 and the second cover plate 210 may each have a cavity such that sufficient space is left to allow up-and-down movement of the resonator. Forming each cavity may comprise providing a hardmask (e.g., a metal hardmask), patterning the hardmask, and etching the cavity using the hardmask as an etching mask. As shown in FIG. 1, a first contact hole 91 may be formed in the first cover plate 110 to allow access to the piezoelectric transducers 20, 60. The contact hole 91 can be formed by, for example, powder blasting.

What is claimed is:

1. A micromachined piezoelectric energy harvester comprising:
a resonating beam formed of a polymer material;
at least one piezoelectric transducer embedded in the resonating beam; and
at least one mass formed on the resonating beam,
wherein the resonating beam is configured to generate mechanical stress in the at least one piezoelectric transducer, and the at least one piezoelectric transducer is configured to generate electrical energy in response to the mechanical stress.

2. The micromachined piezoelectric energy harvester of claim 1, wherein:
the resonating beam comprises a first surface and a second surface; and
the at least one piezoelectric transducer comprises a first piezoelectric transducer embedded in the first surface and a second piezoelectric transducer embedded in the second surface.

3. The micromachined piezoelectric energy harvester of claim 1, wherein:
the resonating beam comprises a first surface and a second surface; and
the at least one mass comprises a first mass formed on the first surface and a second mass formed on the second surface.

4. The micromachined piezoelectric energy harvester of claim 1, wherein the at least one mass comprises silicon.

5. The micromachined piezoelectric energy harvester of claim 1, wherein the at least one mass being formed on the resonating beam comprises the at least one mass being formed on a dielectric disposed on the resonating beam.

6. The micromachined piezoelectric energy harvester of claim 1, wherein the micromachined piezoelectric energy harvester has a symmetric structure.

7. The micromachined piezoelectric energy harvester of claim 1, wherein the at least one piezoelectric transducer comprises a first piezoelectric transducer and a second piezoelectric transducer, and wherein the first piezoelectric transducer and the second piezoelectric transducer are symmetrically embedded in the resonating beam.

8. The micromachined piezoelectric energy harvester of claim 1, wherein the at least one piezoelectric transducer comprises a piezoelectric capacitor structure comprising a stack of a first electrode, a piezoelectric layer and a second electrode.

9. The micromachined piezoelectric energy harvester of claim 1, wherein the at least one piezoelectric transducer comprises a piezoelectric layer, a first interdigitated electrode at a first side of the piezoelectric layer and a second interdigitated electrode at a second side of the piezoelectric layer.

10. The micromachined piezoelectric energy harvester of claim 1, wherein the at least one piezoelectric transducer comprises a plurality of piezoelectric transducers connected series.

11. The micromachined piezoelectric energy harvester of claim 1, wherein the polymer has a Young's modulus lower than 20 GPa.

12. The micromachined piezoelectric energy harvester of claim 1, wherein the resonating beam has a resonance frequency in the range between 50 Hz and 200 Hz.

13. The micromachined piezoelectric energy harvester of claim 1, wherein the micromachined piezoelectric energy harvester has a footprint that is smaller than 1 cm².

14. A micromachined piezoelectric energy harvester, comprising:
a first polymer sub-beam comprising a first surface and a second surface opposite the first surface, the first polymer sub-beam comprising:
a first piezoelectric transducer embedded in the first polymer sub-beam, and a first mass attached to the first surface of the first polymer sub-beam; and
a second polymer sub-beam comprising a first surface and a second surface opposite the first surface, the second polymer sub-beam comprising:
a second piezoelectric transducer embedded in the second polymer sub-beam, and
a second mass attached to the first surface of the second polymer sub-beam, wherein the second surface or the first polymer sub-beam and the second surface of the second polymer sub-beam are connected such that the first polymer sub-beam and the second polymer sub-beam form a resonating beam.

15. The micromachined piezoelectric energy harvester of claim 14, further comprising:
a first cover plate at the first surface of the first polymer sub-beam; and
a second cover plate at the first surface of the second polymer sub-beam.

16. The micromachined piezoelectric energy harvester of claim 14, wherein:
the resonating beam is configured to generate mechanical stress in at least one of the first piezoelectric transducer and the second piezoelectric transducer; and
at least one of the first piezoelectric transducer and the second piezoelectric transducer is configured to generate electrical energy in response to the mechanical stress.

17. A method for fabricating a micromachined piezoelectric energy harvester, the method comprising:
fabricating a first device part comprising:
a first polymer sub-beam comprising a first surface and a second surface,
a first piezoelectric transducer embedded in the first polymer sub-beam, and
a first mass attached to the first surface of the first polymer sub-beam;
fabricating a second device part comprising:
a second polymer sub-beam comprising a first surface and a second surface,
a second piezoelectric transducer embedded in the second polymer sub-beam, and
a second mass attached to the first surface of the second polymer sub-beam;
bonding the first device part to the second device part such that the second surface of the first polymer sub-beam is contact with the second surface of the second polymer sub-beam, thereby forming a resonating beam from the first polymer sub-beam and the second polymer sub-beam; and
performing an etch to release the resonating beam.

18. The method of claim 17, further comprising
attaching a first cover plate at the first surface of the first polymer sub-beam; and
attaching a second cover plate at the first surface of the second polymer sub-beam.

19. The method of claim 19, wherein attaching at least one of the first cover plate and the second cover plate comprises wafer bonding.

20. The method of claim 18, further comprising forming a contact hole through the first cover plate to provide access to at least one of the first piezoelectric transducer and the second piezoelectric transducer.
